(19) United States
(12) Patent Application Publication
(10) Pub. No.: US 2017/0262882 A1
(43) Pub. Date: Sep. 14, 2017

(54) SYSTEMS, MEDIA, AND METHODS FOR PRINTING CUSTOMIZED PAPER RECEIPTS AT THE POINT-OF-SALE

(71) Applicant: AD2POS INC., Pickerington, OH (US)

(72) Inventor: Zion SHINA, Los Angeles, CA (US)

(21) Appl. No.: 15/067,730

(22) Filed: Mar. 11, 2016

(51) Int. Cl. G06Q 30/02; G06Q 20/20

(52) U.S. Cl. CPC G06Q 30/0249; G06Q 30/0275; G06Q 30/0268; G06Q 20/209; G06Q 30/0276

(57) ABSTRACT

Described are systems, media, and methods for providing advertisers access to ad space on printed and electronic receipts and electronic displays at the point of sale.

### BACKGROUND OF THE INVENTION

Presently, over 80% of the approximately 3.6 million retail establishments and specialty stores in the United States are small businesses with a dozen locations or less. These establishments are dispersed throughout the country and cater to a growing number of loyal patrons who prefer to shop locally and who, on average, frequent these establishments several times per week—which translates to millions of transactions per day that create paper and electronic receipts.

### SUMMARY OF THE INVENTION

Each year over 250 billion paper receipts are handed to retail consumers in the U.S. alone. Moreover, there is exponential growth in electronic receipts and state-of-the-art customer displays that support a full range of graphics, audio, and video content. These receipts contain valuable advertising inventory and present repeat opportunities to reinforce messages to consumers via customer displays. Moreover, new electronic receipts, coupled with the use of sophisticated algorithms that programmatically value and match inventory on receipts and point-of-sale displays with dynamic ads and messages, have the potential new revenue streams for merchants and allowing marketers to construct powerful integrated campaigns that simultaneously take full advantage of both the “golden window” of customer attention at the checkout counter, and the ability to put compelling and actionable content directly in the hands of consumers well after the transaction is complete. The systems, media, and methods described herein are designed to maximize the value of dynamic point-of-sale ad inventory for both merchants and display partners providing the ad inventory and marketers by providing access to currently unused advertising space.

The systems, media, and methods described herein instantaneously analyze transaction data and a range of pre-set and dynamic parameters to determine a best match with advertiser content, which is then displayed on the relevant point-of-sale media. Pricing per transaction is programmatically determined by the platform in real-time, debiting the advertiser's account and crediting the display partner's account for every transaction.

The systems, media, and methods described herein enable advertisers to set up and manage local, regional, national and global campaigns based on an expanding selection of criteria and media types. Using a real-time, programmatic pricing model, advertisers are able to establish accounts against which funds are drawn as content is displayed on inventory generated at the point of sale. The value of ad inventory is determined programmatically and the cost of each ad is dynamic within a pre-set range of established parameters controlled by the advertiser. In cases where there are multiple advertisers competing for the same ad space, the advertiser with the highest maximum bid has their ad displayed at a programmatically determined incremental cost above the next highest bidder, not exceeding their maximum bid price.

The systems, media, and methods described herein offer display partners a unique revenue sharing model allowing them to get paid every time a receipt displaying paid advertiser content is printed, paid content is displayed on a customer display, or an electronic receipt containing paid advertiser content is sent to a customer's mobile device or email. The proprietary system analyzes transaction and other data, and dynamically assigns a value to the advertising inventory on paper receipts, electronic receipts and customer displays, and then enables advertisers to bid on ad inventory in real-time. The winning advertiser's content is then displayed in the relevant format (text, graphic, and/or multimedia) and payment is transacted. No changes in display partner behavior or processes or to the point-of-sale infrastructure are required.

The systems, media, and methods described herein enable a growing array of point-of-sale firms, agencies, and other partners to deliver value to existing and potential customers by leveraging the power of our programmatic advertising platform specifically designed to integrate with most point-of-sale printers, customer displays and systems.

In one aspect, disclosed herein are computer-implemented systems comprising: a digital processing device comprising: at least one processor, an operating system configured to perform executable instructions, a memory, and a computer program including instructions executable by the digital processing device to create an application comprising: a software module presenting an interface allowing an advertiser user to configure one or more advertising campaigns, each campaign comprising a region, a start, an end, and a maximum budget; a software module presenting an interface allowing an advertiser user to configure one or more ads, each ad associated with a configured campaign, each ad comprising one or more locations, one or more days, one or more times, content, and a maximum bid; a software module receiving transaction information for a transaction at a point-of-sale system, the information received during the transaction, the information comprising a location; a software module identifying a plurality of suitable ads based on the transaction information and selecting a winning ad based on the maximum bid and the budget during the transaction; and a software module sending receipt print instructions to the point-of-sale system during the transaction, the print instructions comprising the content for the winning ad. In some embodiments, the ad content comprises text, an image, ad, a voucher, a coupon, a URL, a QR code, or a combination thereof. In some embodiments, the transaction information further comprises a consumer identifier and identifying a plurality of suitable ads is further based on the consumer. In some embodiments, the transaction information further comprises a purchase item and identifying a plurality of suitable ads is further based on the purchase item. In some embodiments, the application further comprises a software module receiving transaction completion information for the transaction at the point-of-sale system.

In another aspect, disclosed herein are non-transitory computer-readable storage media encoded with a computer program including instructions executable by a processor to create an application comprising: a database, recorded on the media, of advertising campaigns and associated ads; a software module presenting an interface allowing an advertiser user to configure one or more advertising campaigns, each campaign comprising a region, a start, an end, and a maximum budget; a software module presenting an interface allowing an advertiser user to configure one or more ads, each ad associated with a configured campaign, each ad comprising one or more locations, one or more days, one or more times, content, and a maximum bid; a software module receiving transaction information for a transaction at a point-of-sale system, the information received during the transaction, the information comprising a location; a software module identifying a plurality of suitable ads based on the transaction information and selecting a winning ad based on the maximum bid and the budget during the transaction; and a software module sending receipt print instructions to the point-of-sale system during the transaction, the print instructions comprising the content for the winning ad. In some embodiments, the ad content comprises text, an image, an ad, a voucher, a coupon, a URL, a QR code, or a combination thereof. In some embodiments, the transaction information further comprises a consumer identifier and identifying a plurality of suitable ads is further based on the consumer. In some embodiments, the transaction information further comprises a purchase item and identifying a plurality of suitable ads is further based on the purchase item. In some embodiments, the application further comprises a software module receiving transaction completion information for the transaction at the point-of-sale system.

In another aspect, disclosed herein are computer-implemented methods of providing advertisers access to ad space on printed receipts comprising: presenting, by a computer processor, an interface allowing an advertiser user to configure one or more advertising campaigns, each campaign comprising a region, a start, an end, and a maximum budget; presenting, by the computer processor, an interface allowing an advertiser user to configure one or more ads, each ad associated with a configured campaign, each ad comprising one or more locations, one or more days, one or more times, content, and a maximum bid; receiving, at the computer processor, transaction information for a transaction at a point-of-sale system, the information received during the transaction, the information comprising a location; identifying, by the computer processor, a plurality of suitable ads based on the transaction information and selecting a winning ad based on the maximum bid and the budget during the transaction; and sending, from the computer processor, receipt print instructions to the point-of-sale system during the transaction, the print instructions comprising the content for the winning ad. In some embodiments, the ad content comprises text, an image, ad, a voucher, a coupon, a URL, a QR code, or a combination thereof. In some embodiments, the transaction information further comprises a consumer identifier and identifying a plurality of suitable ads is further based on the consumer. In some embodiments, the transaction information further comprises a purchase item and identifying a plurality of suitable ads is further based on the purchase item. In some embodiments, the method further comprises receiving, at the computer processor, transaction completion information for the transaction at the point-of-sale system.

In another aspect, disclosed herein are computer-implemented systems comprising: a digital processing device comprising: at least one processor, an operating system configured to perform executable instructions, a memory, and a computer program including instructions executable by the digital processing device to create an application comprising: a software module presenting an interface allowing an advertiser user to configure one or more advertising campaigns, each campaign comprising a region, a start, an end, and a maximum budget; a software module presenting an interface allowing an advertiser user to configure one or more ads, each ad associated with a configured campaign, each ad comprising one or more locations, one or more days, one or more times, content, and a maximum bid; a software module receiving transaction information for a transaction at a point-of-sale system, the information received during the transaction, the information comprising a location; a software module identifying a plurality of suitable ads based on the transaction information and selecting a winning ad based on the maximum bid and the budget during the transaction; and a software module sending display instructions to the point-of-sale system during the transaction, the display instructions comprising the content for the winning ad. In some embodiments, the ad content comprises text, an image, a video, a URL, a QR code, or a combination thereof. In some embodiments, the transaction information further comprises a consumer identifier and identifying a plurality of suitable ads is further based on the consumer. In some embodiments, the transaction information further comprises a purchase item and identifying a plurality of suitable ads is further based on the purchase item. In some embodiments, the application further comprises a software module receiving transaction completion information for the transaction at the point-of-sale system.

In another aspect, disclosed herein are non-transitory computer-readable storage media encoded with a computer program including instructions executable by a processor to create an application comprising: a software module presenting an interface allowing an advertiser user to configure one or more advertising campaigns, each campaign comprising a region, a start, an end, and a maximum budget; a software module presenting an interface allowing an advertiser user to configure one or more ads, each ad associated with a configured campaign, each ad comprising one or more locations, one or more days, one or more times, content, and a maximum bid; a software module receiving transaction information for a transaction at a point-of-sale system, the information received during the transaction, the information comprising a location; a software module identifying a plurality of suitable ads based on the transaction information and selecting a winning ad based on the maximum bid and the budget during the transaction; and a software module sending display instructions to the point-of-sale system during the transaction, the display instructions comprising the content for the winning ad. In some embodiments, the ad content comprises text, an image, a video, a URL, a QR code, or a combination thereof. In some embodiments, the transaction information further comprises a consumer identifier and identifying a plurality of suitable ads is further based on the consumer. In some embodiments, the transaction information further comprises a purchase item and identifying a plurality of suitable ads is further based on the purchase item. In some embodiments, the application further comprises a software module receiving transaction completion information for the transaction at the point-of-sale system.

In another aspect, disclosed herein are computer-implemented methods of providing advertisers access to ad space on electronic display screens at the point of sale comprising: presenting, by a computer processor, an interface allowing an advertiser user to configure one or more advertising campaigns, each campaign comprising a region, a start, an end, and a maximum budget; presenting, by the computer processor, an interface allowing an advertiser user to configure one or more ads, each ad associated with a configured campaign, each ad comprising one or more locations, one or more days, one or more times, content, and a maximum bid; receiving, by the computer processor, transaction information for a transaction at a point-of-sale system, the information received during the transaction, the information comprising a location; identifying, by the computer processor, a plurality of suitable ads based on the transaction information and selecting a winning ad based on the maximum bid and the budget during the transaction; and sending, by the computer processor, display instructions to the point-of-sale system during the transaction, the display instructions comprising the content for the winning ad. In some embodiments, the ad content comprises text, an image, a video, a URL, a QR code, or a combination thereof. In some embodiments, the transaction information further comprises a consumer identifier and identifying a plurality of suitable ads is further based on the consumer. In some embodiments, the transaction information further comprises a purchase item and identifying a plurality of suitable ads is further based on the purchase item. In some embodiments, the method further comprises receiving, by the computer processor, transaction completion information for the transaction at the point-of-sale system.

### BRIEF DESCRIPTION OF THE DRAWINGS

FIG. 1 shows a non-limiting example of schematic diagram; in this case, a schematic diagram depicting multiple user types.

FIG. 2 shows a non-limiting example of a process flow diagram; in this case, a process flow diagram depicting a process wherein a winning advertiser is determined by the described system.

FIG. 3 shows a non-limiting example of a process flow diagram; in this case, a process flow diagram depicting a process wherein a winning advertiser is determined by a third party ad exchange or ad network.

FIG. 4 shows non-limiting examples of suitable inventory and content types; in this case, an electronic receipt including video, graphic, link, text, or audio content, a customer display including video, graphic, link, text, or audio content, and a paper receipt including link or text content.

FIG. 5 shows a non-limiting example of process flow diagram; in this case, a process flow diagram for an advertiser user type.

FIG. 6 shows a non-limiting example of a user interface; in this case, an advertiser dashboard.

FIG. 7 shows a non-limiting example of a user interface; in this case, an advertiser campaign screen.

FIG. 8 shows a non-limiting example of a user interface; in this case, an advertiser campaign creation wizard.

FIG. 9 shows a non-limiting example of a user interface; in this case, an advertiser new campaign screen.

FIG. 10 shows a non-limiting example of a user interface; in this case, an advertiser new ad screen.

FIG. 11 shows a non-limiting example of a user interface; in this case, an advertiser campaign billing screen.

FIG. 12 shows a non-limiting example of a user interface; in this case, an advertiser campaign summary.

FIG. 13 shows a non-limiting example of a user interface; in this case, an advertiser campaign detail.

FIG. 14 shows a non-limiting example of an approval communication; in this case, an email to an administrator indicating that a new ad is awaiting approval.

FIG. 15 shows a non-limiting example of process flow diagram; in this case, a process flow diagram for a display partner user type.

FIG. 16 shows a non-limiting example of a user interface; in this case, a display partner application screen.

FIG. 17 shows a non-limiting example of an approval communication; in this case, an email to an administrator indicating that a new display partner application is awaiting approval.

FIG. 18 shows a non-limiting example of a user interface; in this case, an administrator account management screen.

FIG. 19 shows a non-limiting example of a user interface; in this case, a display partner approval/rejection screen.

FIG. 20 shows a non-limiting example of a user interface; in this case, an administrator display partner management screen.

FIG. 21 shows a non-limiting example of process flow diagram; in this case, a process flow diagram for a software partner user type.

FIG. 22 shows a non-limiting example of a user interface; in this case, a software partner application screen.

FIG. 23 shows a non-limiting example of a user interface; in this case, a software partner approval/rejection screen.

FIG. 24 shows a non-limiting example of a user interface; in this case, a screen showing that an approved software partner appears in a list allowing selection of software on a display partner screen.

FIG. 25 shows a non-limiting example of a user interface; in this case, an administrator software partner management screen.

FIG. 26 shows a non-limiting example of process flow diagram; in this case, a process flow diagram for an affiliate partner user type.

FIG. 27 shows a non-limiting example of a user interface; in this case, an affiliate partner application screen.

FIG. 28 shows a non-limiting example of a user interface; in this case, an affiliate partner approval/rejection screen.

FIG. 29 shows a non-limiting example of an approval communication; in this case, an email to an affiliate partner indicating approval or rejection their application.

FIG. 30 shows a non-limiting example of a user interface; in this case, a screen showing that an approved affiliate partner appears in a list allowing selection of affiliate on an advertiser partner screen.

FIG. 31 shows a non-limiting example of a suitable advertisement; in this case, an advertisement suitable for printing on the back of a printed receipt.

### DETAILED DESCRIPTION OF THE INVENTION

Described herein, in certain embodiments, are computer-implemented systems comprising: a digital processing device comprising: at least one processor, an operating system configured to perform executable instructions, a memory, and a computer program including instructions executable by the digital processing device to create an application comprising: a software module presenting an interface allowing an advertiser user to configure one or more advertising campaigns, each campaign comprising a region, a start, an end, and a budget; a software module presenting an interface allowing an advertiser user to configure one or more ads, each ad associated with a configured campaign, each ad comprising one or more locations, one or more days, one or more times, content, and a maximum bid; a software module receiving transaction information for a transaction at a point-of-sale system, the information received during the transaction, the information comprising a location; a software module identifying a plurality of suitable ads based on the transaction information and selecting a winning ad based on the maximum bid and the budget during the transaction; and a software module sending receipt print instructions to the point-of-sale system, the print instructions comprising the content for the winning ad.

Also described herein, in certain embodiments, are non-transitory computer-readable storage media encoded with a computer program including instructions executable by a processor to create an application comprising: a database, recorded on the media, of advertising campaigns and associated ads; a software module presenting an interface allowing an advertiser user to configure one or more advertising campaigns, each campaign comprising a region, a start, an end, and a budget; a software module presenting an interface allowing an advertiser user to configure one or more ads, each ad associated with a configured campaign, each ad comprising one or more locations, one or more days, one or more times, content, and a maximum bid; a software module receiving transaction information for a transaction at a point-of-sale system, the information received during the transaction, the information comprising a location; a software module identifying a plurality of suitable ads based on the transaction information and selecting a winning ad based on the maximum bid and the budget during the transaction; and a software module sending receipt print instructions to the point-of-sale system, the print instructions comprising the content for the winning ad.

Also described herein, in certain embodiments, are computer-implemented methods of providing advertisers access to ad space on printed receipts comprising: presenting, by a computer processor, an interface allowing an advertiser user to configure one or more advertising campaigns, each campaign comprising a region, a start, an end, and a budget; presenting, by the computer processor, an interface allowing an advertiser user to configure one or more ads, each ad associated with a configured campaign, each ad comprising one or more locations, one or more days, one or more times, content, and a maximum bid; receiving, at the computer processor, transaction information for a transaction at a point-of-sale system, the information received during the transaction, the information comprising a location; identifying, by the computer processor, a plurality of suitable ads based on the transaction information and selecting a winning ad based on the maximum bid and the budget during the transaction; and sending, from the computer processor, receipt print instructions to the point-of-sale system, the print instructions comprising the content for the winning ad.

Also described herein, in certain embodiments, are computer-implemented systems comprising: a digital processing device comprising: at least one processor, an operating system configured to perform executable instructions, a memory, and a computer program including instructions executable by the digital processing device to create an application comprising: a software module presenting an interface allowing an advertiser user to configure one or more advertising campaigns, each campaign comprising a region, a start, an end, and a budget; a software module presenting an interface allowing an advertiser user to configure one or more ads, each ad associated with a configured campaign, each ad comprising one or more locations, one or more days, one or more times, content, and a maximum bid; a software module receiving transaction information for a transaction at a point-of-sale system, the information received during the transaction, the information comprising a location; a software module identifying a plurality of suitable ads based on the transaction information and selecting a winning ad based on the maximum bid and the budget during the transaction; and a software module sending display instructions to the point-of-sale system, the display instructions comprising the content for the winning ad.

Also described herein, in certain embodiments, are non-transitory computer-readable storage media encoded with a computer program including instructions executable by a processor to create an application comprising: a software module presenting an interface allowing an advertiser user to configure one or more advertising campaigns, each campaign comprising a region, a start, an end, and a budget; a software module presenting an interface allowing an advertiser user to configure one or more ads, each ad associated with a configured campaign, each ad comprising one or more locations, one or more days, one or more times, content, and a maximum bid; a software module receiving transaction information for a transaction at a point-of-sale system, the information received during the transaction, the information comprising a location; a software module identifying a plurality of suitable ads based on the transaction information and selecting a winning ad based on the maximum bid and the budget during the transaction; and a software module sending display instructions to the point-of-sale system, the display instructions comprising the content for the winning ad.

Also described herein, in certain embodiments, are computer-implemented methods of providing advertisers access to ad space on electronic display screens at the point of sale comprising: presenting, by a computer processor, an interface allowing an advertiser user to configure one or more advertising campaigns, each campaign comprising a region, a start, an end, and a budget; presenting, by the computer processor, an interface allowing an advertiser user to configure one or more ads, each ad associated with a configured campaign, each ad comprising one or more locations, one or more days, one or more times, content, and a maximum bid; receiving, by the computer processor, transaction information for a transaction at a point-of-sale system, the information received during the transaction, the information comprising a location; identifying, by the computer processor, a plurality of suitable ads based on the transaction information and selecting a winning ad based on the maximum bid and the budget during the transaction; and sending, by the computer processor, display instructions to the point-of-sale system, the display instructions comprising the content for the winning ad.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### User Types

In some embodiments, the platforms, systems, media, and methods described herein include a plurality of user types, or use of the same. Many user types are suitable including those representing participants or stakeholders in advertising, brick-and-mortar commerce, point-of-sale hardware and software, consumer advocacy, and the like. In some embodiments, the interfaces presented and the features available are customized based on the user type of a particular user. In further embodiments, each set of log in credentials is associated with a user type. In still further embodiments, a user selects their user type, for example, by selecting a user type from a list of user types. In various embodiments, suitable user types include, by way of non-limiting examples, advertising affiliate partner and/or ad agency partner, advertiser, software partner, display partner, and the like. In some embodiments, user types are associated with each other to represent commercial relationships and arrangements to share revenue from particular advertising events.

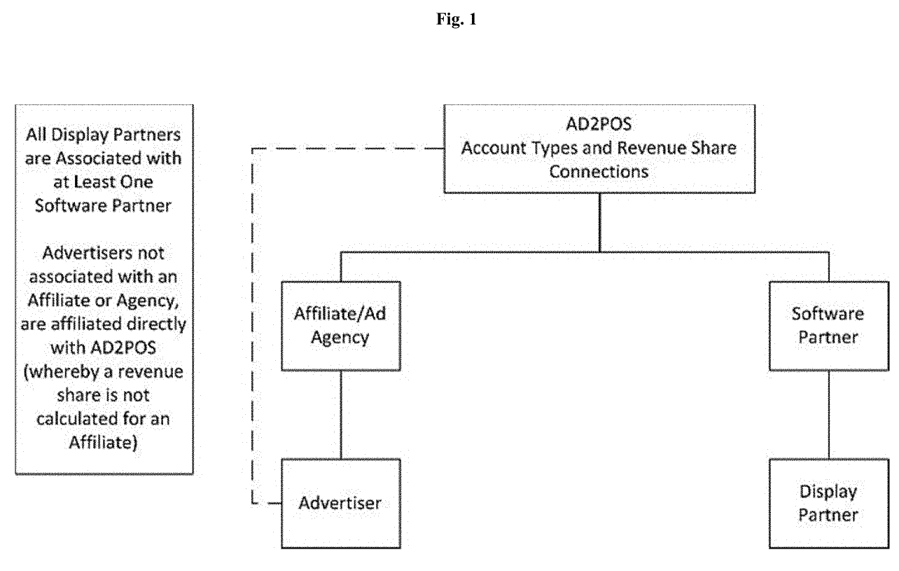

Referring to FIG. 1, in a particular embodiment, a provider of the technology described herein allows registration of advertising affiliate partners and/or ad agency partners, advertisers, software partners, and display partners. In this embodiment, each display partner is associated with at least one software partner. Further, in this embodiment, any advertiser not associated with an advertising affiliate or ad agency is directly associated with the service provider.

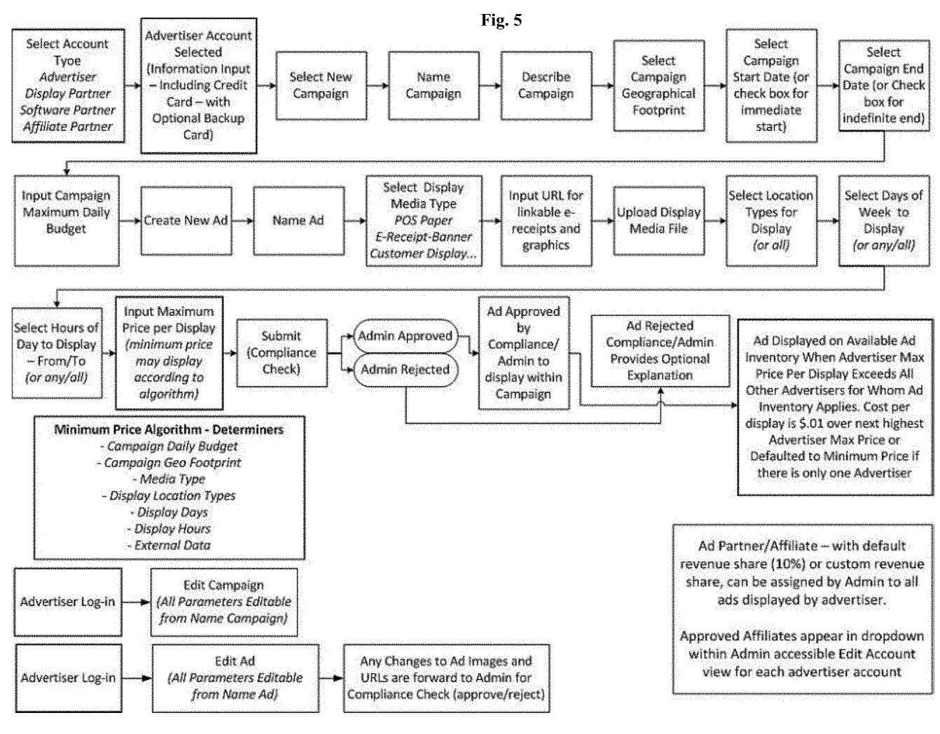

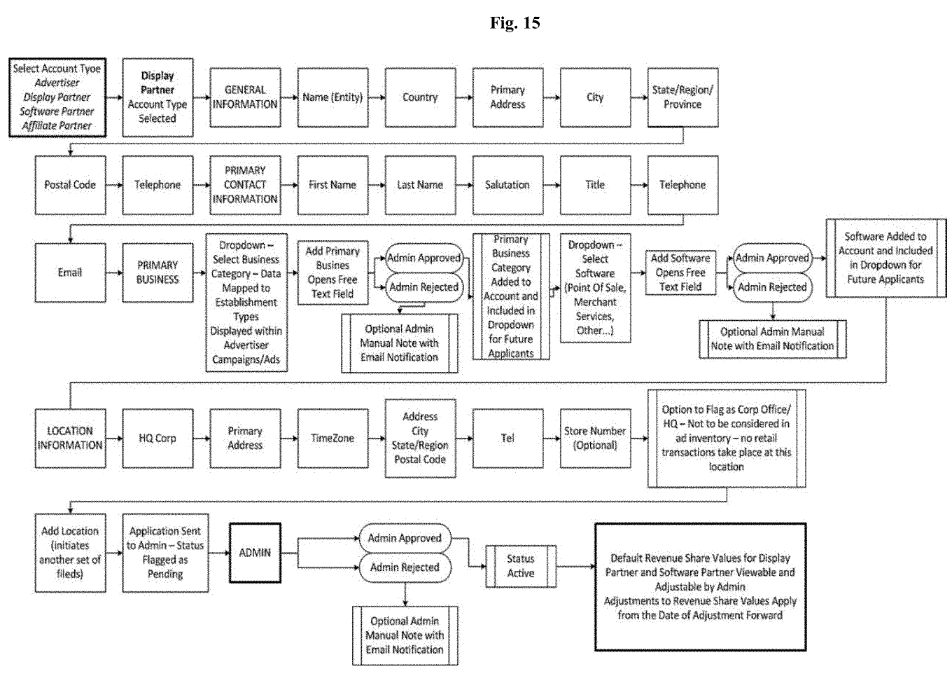

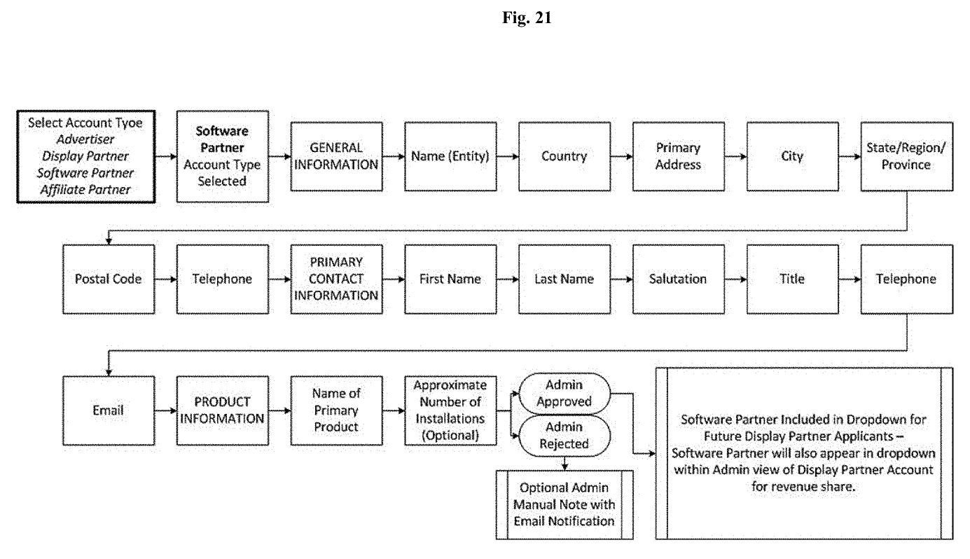

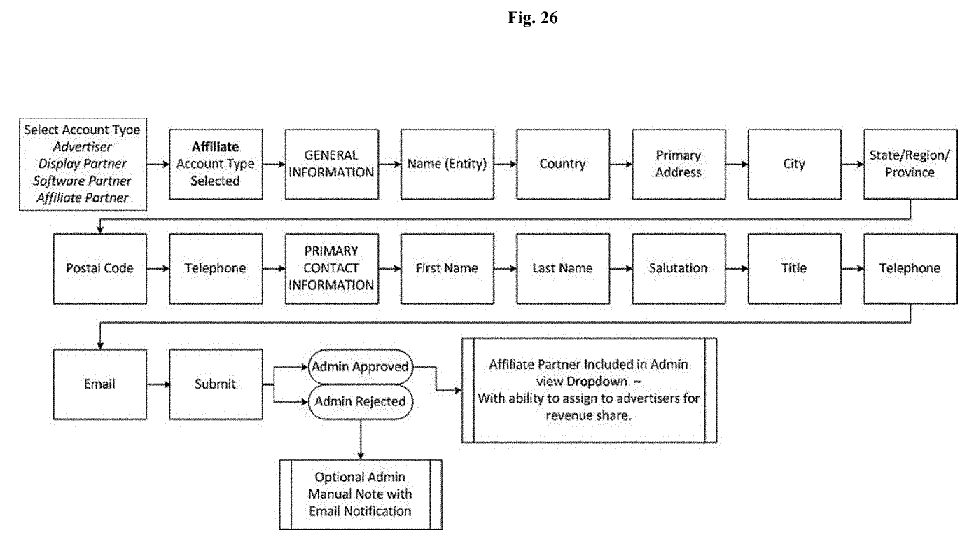

In some embodiments, users identify their user type. In other embodiments, the described platforms, systems, media, and methods identify the user type of a user. In some embodiments, workflows differ based on user type. See, e.g., FIG. 5 (exemplary advertiser workflow), FIG. 15 (exemplary display partner workflow), FIG. 21 (exemplary software partner workflow), and FIG. 26 (exemplary affiliate workflow).

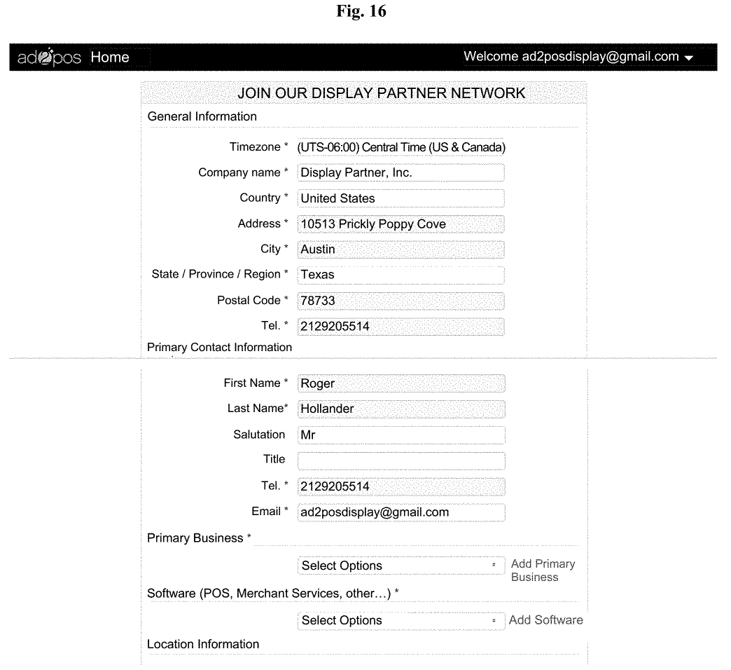

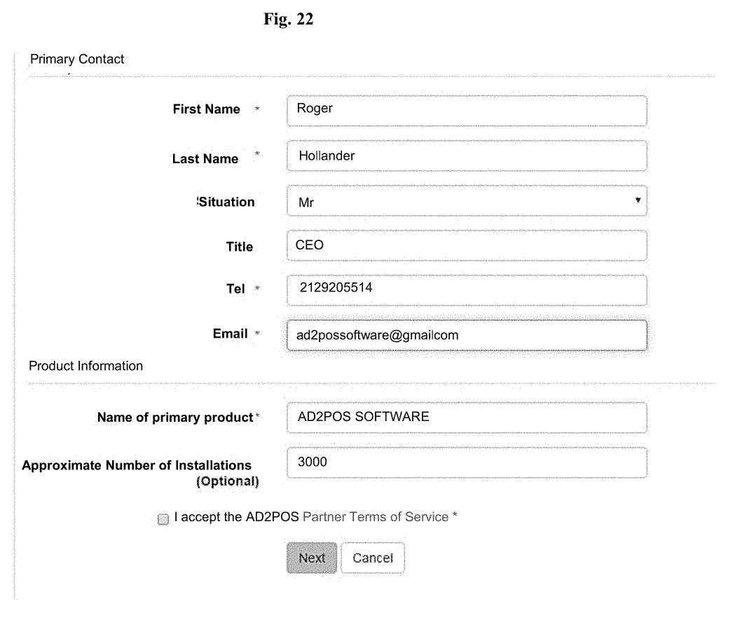

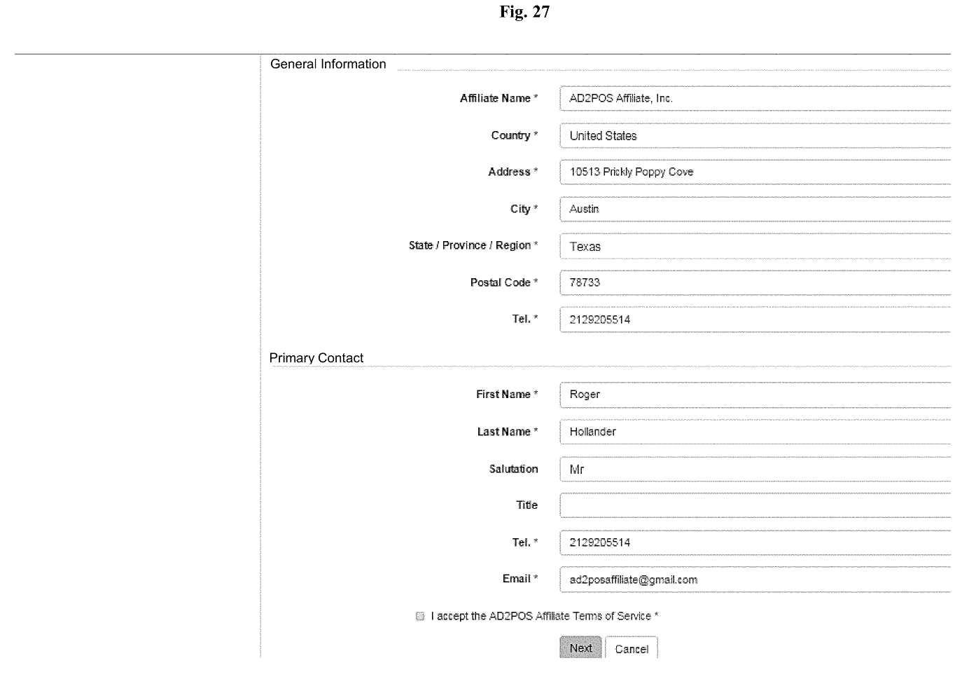

In some embodiments, the platforms, systems, media, and methods described herein include a specialized application screen for each user type, or use of the same; for example, a display partner application screen (see FIG. 16), a software partner application screen (see FIG. 22), and an affiliate partner application screen (see FIG. 27).

### Overview

The overall architecture of the described platforms, systems, media, and methods is variable.

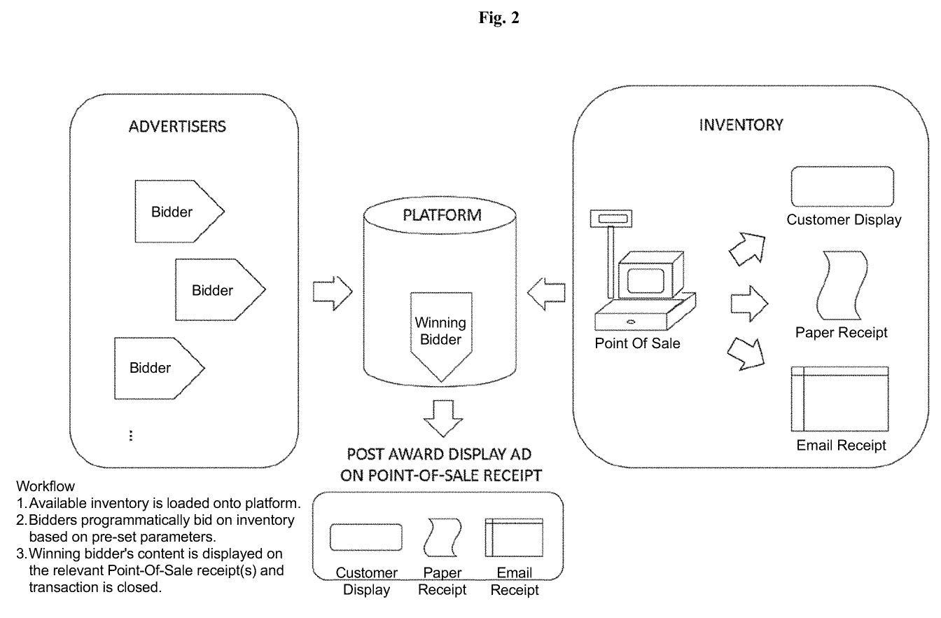

Referring to FIG. 2, in a particular embodiment, available point-of-sale inventory is loaded onto the described system, advertisers programmatically bid on the inventory based on pre-set parameters, and a winning bidder's ad content is displayed on the relevant point-of-sale receipt(s) (e.g., customer display, paper receipt, and/or email receipt), and the transaction is closed.

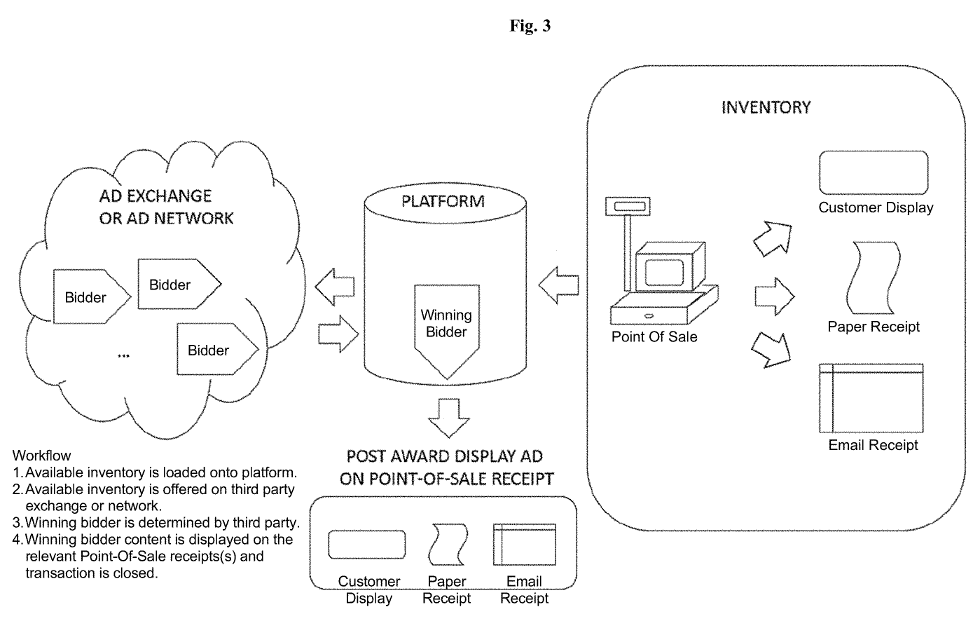

Referring to FIG. 3, in a particular embodiment, available point-of-sale inventory is loaded onto the described system, available inventory is offered on a third-party ad exchange or ad network, a winning bidder is determined by the third-party, the winning bidder's ad content is displayed on the relevant point-of-sale receipt(s) (e.g., customer display, paper receipt, and/or email receipt), and the transaction is closed.

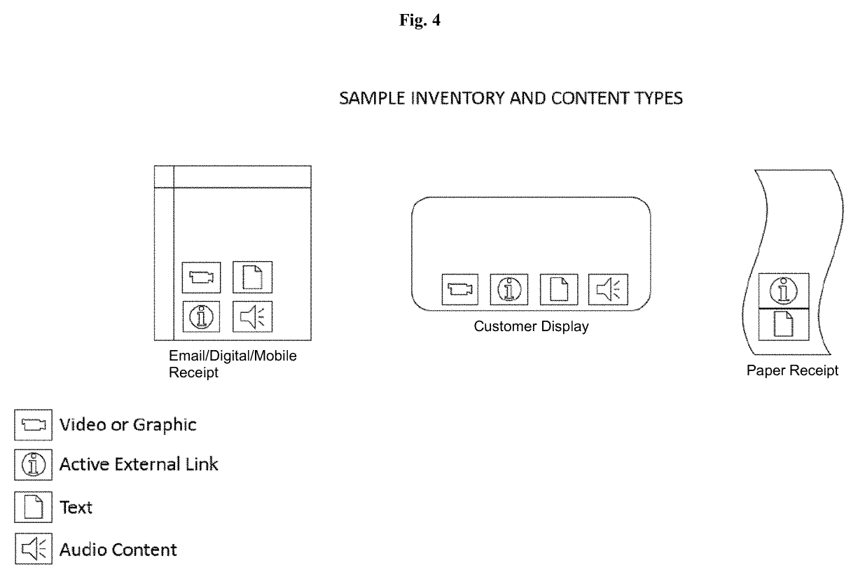

Referring to FIG. 4, in a particular embodiment, inventory includes 1) email receipts, digital receipts, or mobile receipts, which optionally include ad content such as video, graphics, links, text, and/or audio 2) customer displays, which optionally include ad content such as video, graphics, links, text, and/or audio, and 3) paper receipts, which optionally include ad content such as graphics, text, and/or links.

The roles of different user types in the overall process differ.

Referring to FIG. 5 (advertiser workflow), in a particular embodiment, an advertiser selects “New Campaign,” names the campaign, describes the campaign, selects a geographical footprint, start date, end date, and maximum daily budget for the campaign. Continuing to refer to FIG. 5, an advertiser selects “Create New Ad,” names the ad, selects a display media type (e.g., paper, email, electronic display, etc.), inputs one or more URLs for links, uploads one or more media, and selects location, days of the week, and hours of the day for the ad to be displayed. Finally, in this embodiment, the advertiser inputs a maximum price per display of the ad. Continuing to refer to FIG. 5, the ad is optionally subjected to a compliance check by an administrator, if approved; the ad is displayed on available ad inventory when the advertiser's maximum price per ad exceeds all other advertisers for whom the ad inventory applies. Subsequently, the advertiser optionally edits the campaign and/or the ad.

Referring to FIG. 15 (display partner workflow), in a particular embodiment, a display partner enters general information such as name, country, primary address, city, state, postal code, telephone, and primary contact information. Continuing to refer to FIG. 15, a display partner selects a business category, applicable software, and locations, all of which are optionally subjected to a compliance check by an administrator.

Referring to FIG. 21 (software partner workflow), in a particular embodiment, a software partner enters general information such as name, country, primary address, city, state, postal code, telephone, and primary contact information. Continuing to refer to FIG. 21, a software partner enters product information, including product name and optionally an approximate number of installations, which is optionally subjected to a compliance check by an administrator. Once registered, a software partner appears in selection menus for future display partner applicants.

Referring to FIG. 26 (affiliate partner workflow), in a particular embodiment, an affiliate partner enters general information such as name, country, primary address, city, state, postal code, telephone, and primary contact information, which is optionally subjected to a compliance check by an administrator.

### Advertising Campaigns

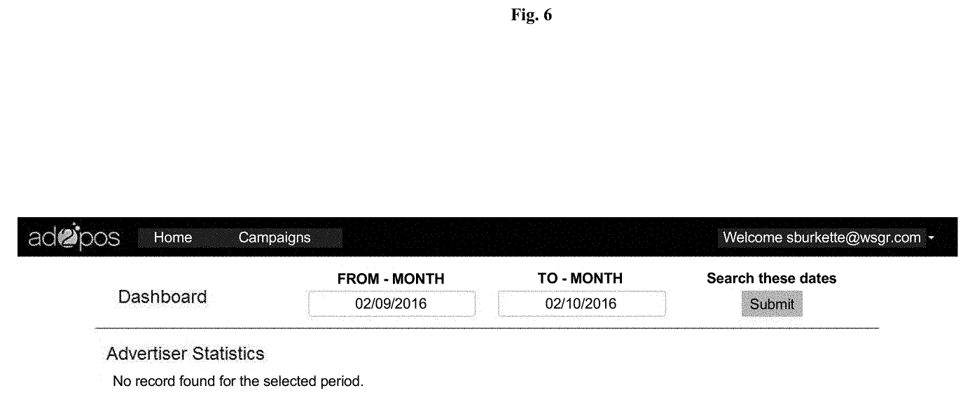

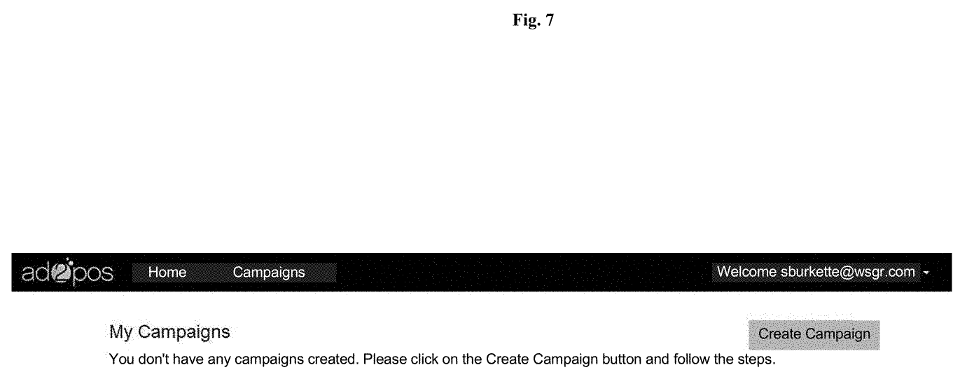

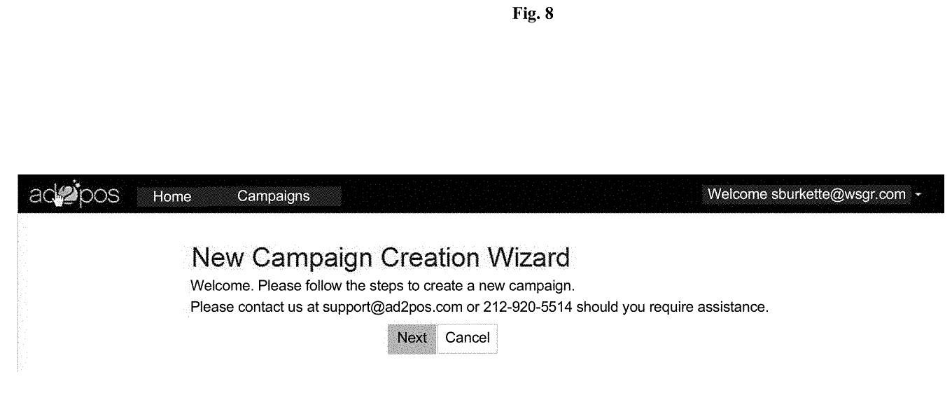

In some embodiments, the platforms, systems, media, and methods described herein include one or more advertising campaigns, or use of the same. In further embodiments, advertising campaigns are configured via an advertiser dashboard (see FIG. 6), which provides advertiser statistics and access to an advertiser campaign page (see FIG. 7). In some embodiments, an advertiser configures new campaigns via a new campaign creation wizard (see FIG. 8).

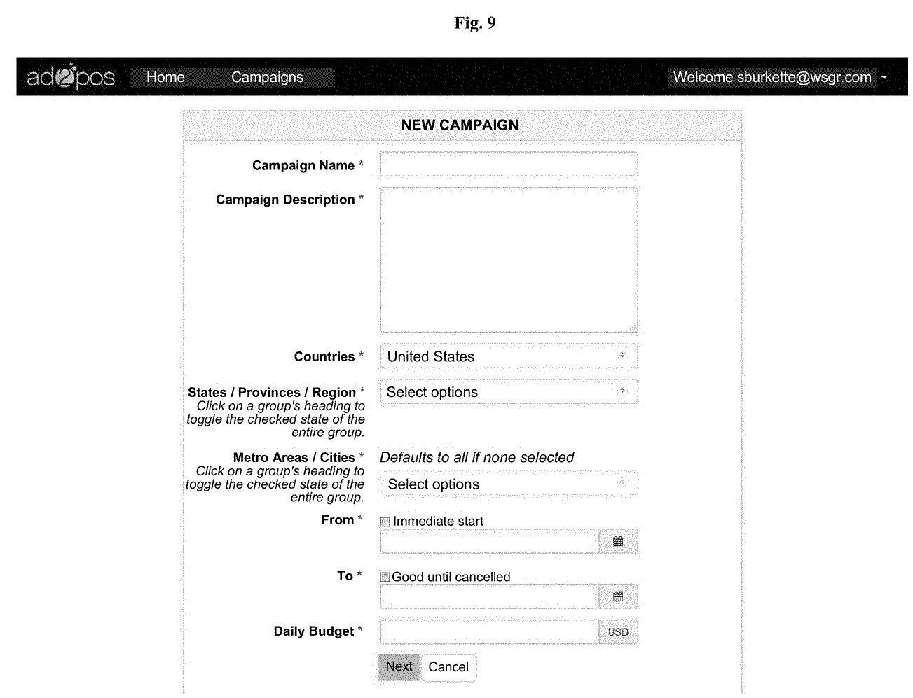

Referring to FIG. 9, in a particular embodiment, a new campaign creation wizard allows an advertiser to configure a new campaign by entering a campaign name, a campaign description, countries in which to run the campaign, and in each country, the relevant states or regions, and in each state or region, the relevant areas or cities. Continuing to refer to FIG. 9, in this embodiment, an advertiser further configures a new campaign by entering a start date (or immediate start), an end date (or good until cancelled), and a maximum daily budget.

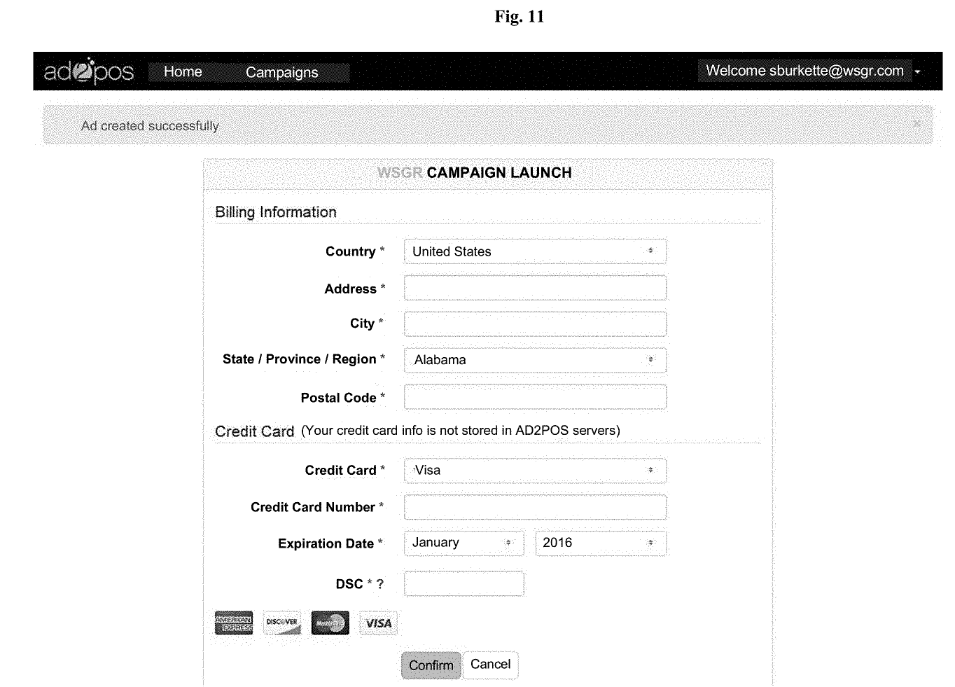

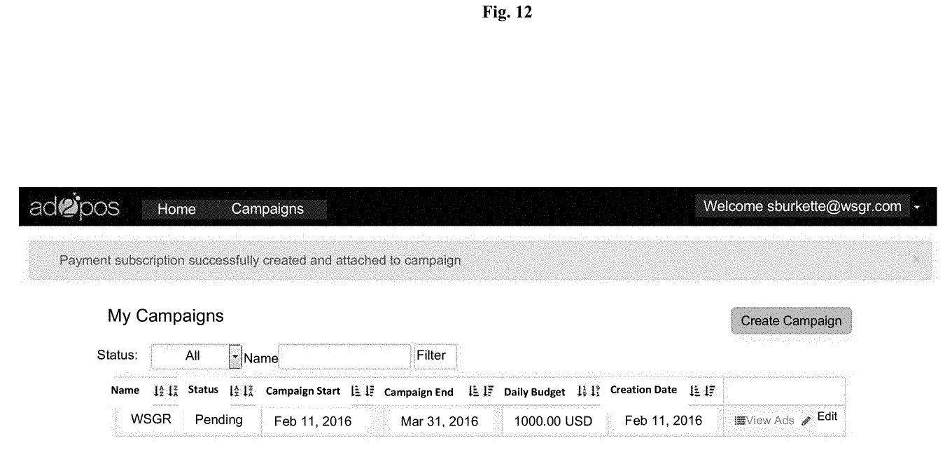

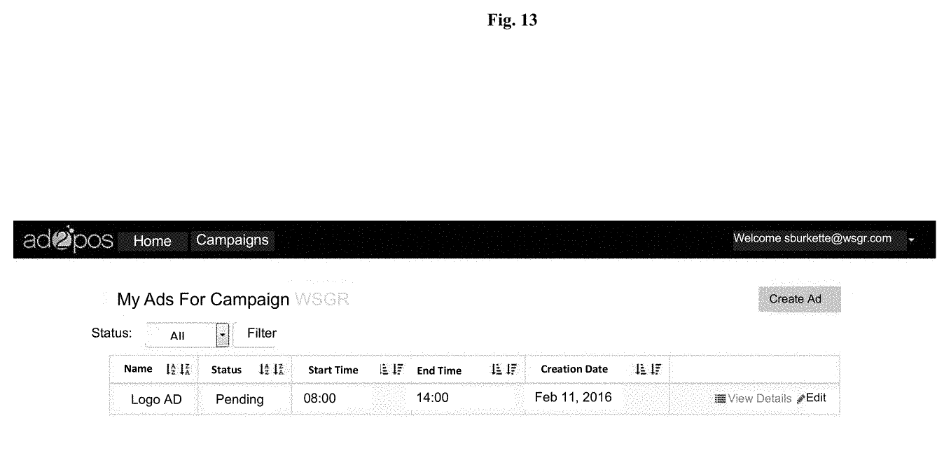

In some embodiments, an advertiser links an advertising campaign or one or more ads to billing information and/or credit card information to pay the service provider's fees (see FIG. 11). In further embodiments, configured campaigns appear in the advertiser's campaign summary page (see FIG. 12), where basic configuration data is provided for each configured campaign as well as access to features for viewing details of associated ads (see FIG. 13) and editing the campaign.

### Ads

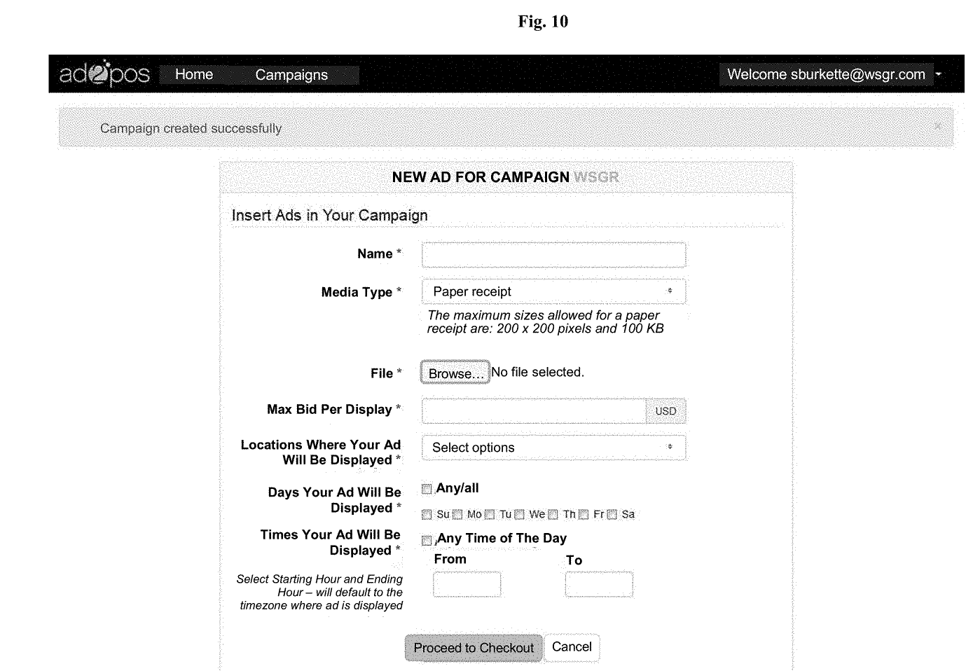

In some embodiments, the platforms, systems, media, and methods described herein include one or more ads, or use of the same. In some embodiments, each advertising campaign is associated with one or more ads. In some embodiments, an advertiser configures new ads within an advertising campaign via a specialized interface (see FIG. 10).

Referring to FIG. 10, in a particular embodiment, a specialized ad creation interface allows an advertiser to configure an ad by entering an ad name and a media type (e.g., media on which the ad is to appear). Further in this embodiment, an advertiser configures an ad by selecting one or more ad content file(s) (e.g., text file, graphics file, video file, interactive file, or a combination thereof). Continuing to refer to FIG. 10, in this embodiment, an advertiser further configures an ad by entering a maximum bid per display, locations where the ad will be displayed, and days and times when the ad will be displayed.

Many types of ad content files are suitable. In some embodiments, suitable ad content files include text, documents, e-books, audio, images (e.g., photographs, illustrations, etc.), videos, multimedia (e.g., interactive elements, games, etc.), or combinations of the same.

Many text formats are suitable including, by way of non-limiting examples, Rich Text Format (RTF), TXT, ASCII, UTF-8, and HTML formatted text. Many document formats are suitable including, by way of non-limiting examples, Microsoft® Office Word®, Microsoft® Office PowerPoint®, Microsoft Office Excel®, DocBook, HTML, OpenDocument, PalmDoc, Portable Document Format (PDF), Rich Text Format (RTF), and WordPerfect.

Many e-book formats are suitable including, by way of non-limiting examples, plain text, hypertext markup language (HTML), Amazon® Kindle™, Open Electronic Package, TomeRaider, Arghos Diffusion, Flip Books, ANSI/NISO Z39.86 (DAISY), FictionBook, Text Encoding Initiative, Plucker, Compressed HM, Portable Document Format, PostScript, DjVu, Microsoft LIT, eReader, Desktop Author, Newton eBook, Founder Electronics, Libris, Mobipocket, EPUB, Broadband eBooks (BBeB), SSReader, TealDoc, IEC 62448, and Comic Book Archive file. Suitable e-books include those formatted for viewing on, by way of non-limiting examples, Apple® iPad®, Amazon® Kindle™, Barnes & Noble Nook™, Sony® Reader™, iRex iLiad, the Jinke Hanlin eReader, Bookeen CyBook, Endless Ideas BeBook, and the Kobo™ eReader.

Many audio formats are suitable including, by way of non-limiting examples, MP3, WAV, AIFF, AU, Apple® Lossless, MPEG-4, Windows Media®, Vorbis, AAC, and Real Audio®.

Many raster image formats are suitable including, by way of non-limiting examples, Joint Photographic Experts Group (JPEG), JPEG 2000, Exchangeable image file format (EXIF), Tagged Image File Format (TIFF), RAW, Portable Network Graphics (PNG), Graphics Interchange Format (GIF), Windows® bitmap (BMP), portable pixmap (PPM), portable graymap (PGM), portable bitmap file format (PBM), wireless bitmap (WBMP), and WebP. In some embodiments, images are uncompressed (e.g., RAW format). In other embodiments, images are compressed. Both lossy and lossless image CODECs are suitable. Many vector image formats are suitable including, by way of non-limiting examples, CGM and SWF. Both two-dimensional and three-dimensional vector images are suitable.

Many video formats are suitable including, by way of non-limiting examples, Windows® Media Video (WMV), Windows® Media®, Motion Picture Experts Group (MPEG), Audio Video Interleave (AVI), Apple® QuickTime®, RealMedia®, Flash Video, Motion JPEG (M-JPEG), WebM, and Advanced Video Coding High Definition (AVCHD). In some embodiments, video is uncompressed (e.g., RAW format). In other embodiments, video is compressed. Both lossy and lossless video CODECs are suitable including, by way of non-limiting examples, DivX™ Cineform, Cinepak, Dirac, DV, FFV1, H.263, H.264, H.264 lossless, JPEG 2000, MPEG-1, MPEG-2, MPEG-4, On2 Technologies (VP5, VP6, VP7, and VP8), RealVideo, Snow lossless, Sorenson Video, Theora, and Windows Media Video (WMV).

In some embodiments, image and/or video media are standard-definition. In other embodiments, image and/or video media are high-definition. In further embodiments, a high-definition image or video frame includes at least about 1280×about 720 pixels or at least about 1920×about 1080 pixels.

Many multimedia formats are suitable including, by way of non-limiting examples, Adobe® Flash®, Apple® QuickTime®, Microsoft® Silverlight®, Java™, HTML 5, XHTML 5, and Unity®.

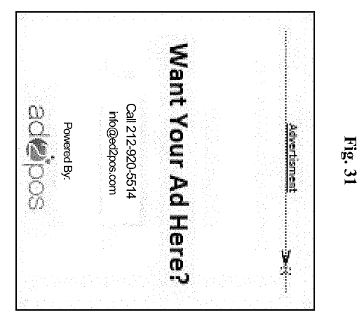

Referring to FIG. 31, in a particular embodiment, an ad content file includes text and graphics suitable for printing on the back of a printed receipt.

### Compliance Process

In some embodiments, the platforms, systems, media, and methods described herein include a compliance process, or use of the same. Because of the real time nature of the user and ad data described, a compliance process optionally allows one or more administrators to review and approved/reject new users, campaigns, ads, edits thereto, and the like. In some embodiments, a reviewing administrator is associated with a provider of the platforms, systems, media, and methods described herein. In other embodiments, a reviewing administrator is associated with a user, such as an advertising affiliate partner, an ad agency partner, an advertiser, a software partner, a display partner, or a group consisting of a combination thereof.

Many events described herein are suitably subject to compliance review. In various embodiments, new advertising campaigns, edits to campaigns, new ads, edits to ads, new user registration, and edits to user profiles are suitably subject to review. In some embodiments, an administrator is provided specialized interfaces for reviewing and subsequently approving or rejecting events.

In some embodiments, a compliance process is carried out via electronic communications. Suitable electronic communications include, by way of non-limiting examples, email, text message, automated phone call, instant message, social media post, microblog post, and/or notification within the platforms, systems, and applications described herein.

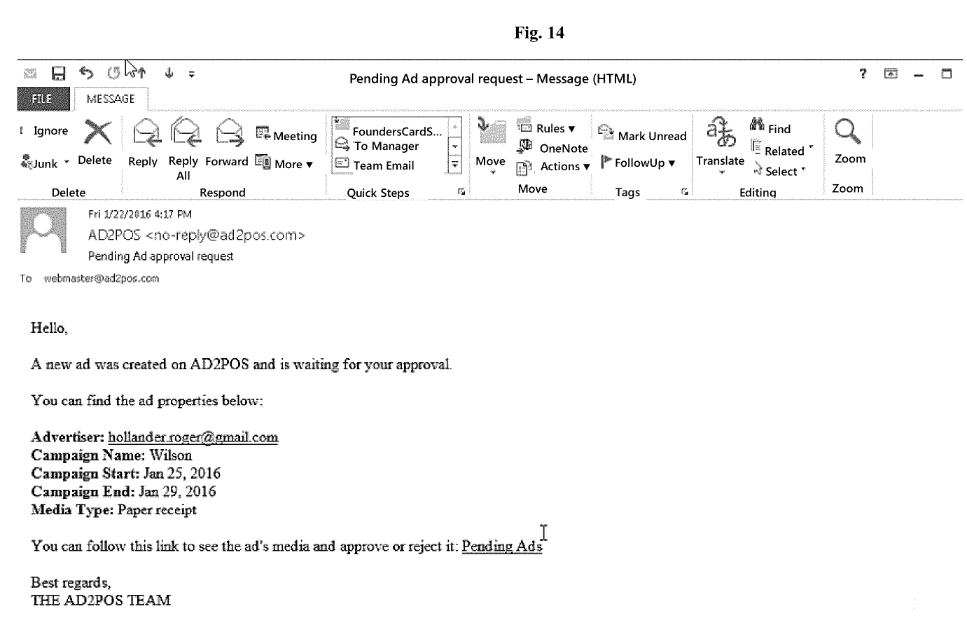

Referring to FIG. 14, in a particular embodiment, a compliance process includes an automated email sent to an administrator alerting them to a newly created ad that awaits their review. In this embodiment, the email includes the advertiser, the campaign name, the start date, the end date, the media type, and a link to view the ad.

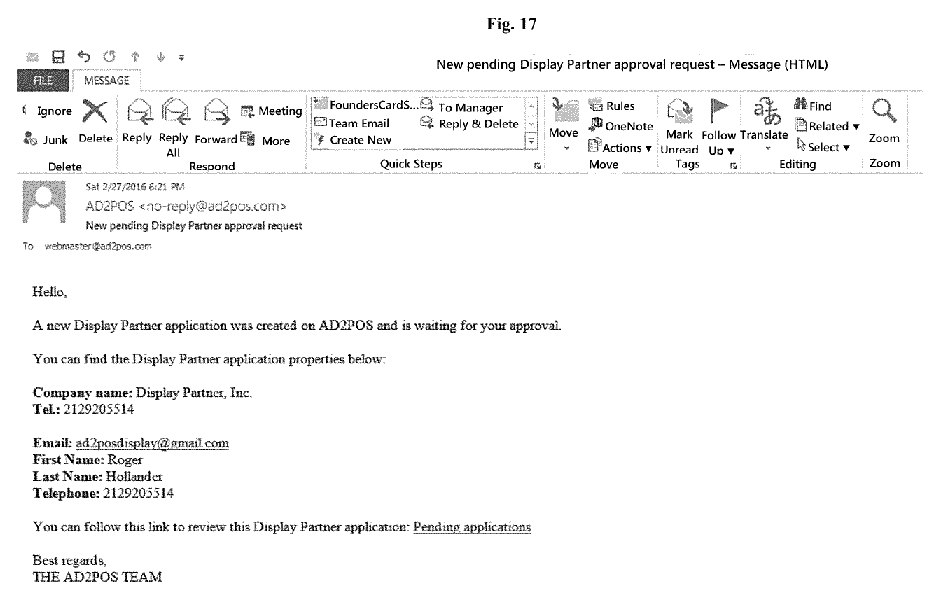

Referring to FIG. 17, in a particular embodiment, a compliance process includes an automated email sent to an administrator alerting them to a new display partner application that awaits their review.

In some embodiments, a compliance process is carried out via an administrative interface allowing an administrator to manage user accounts.

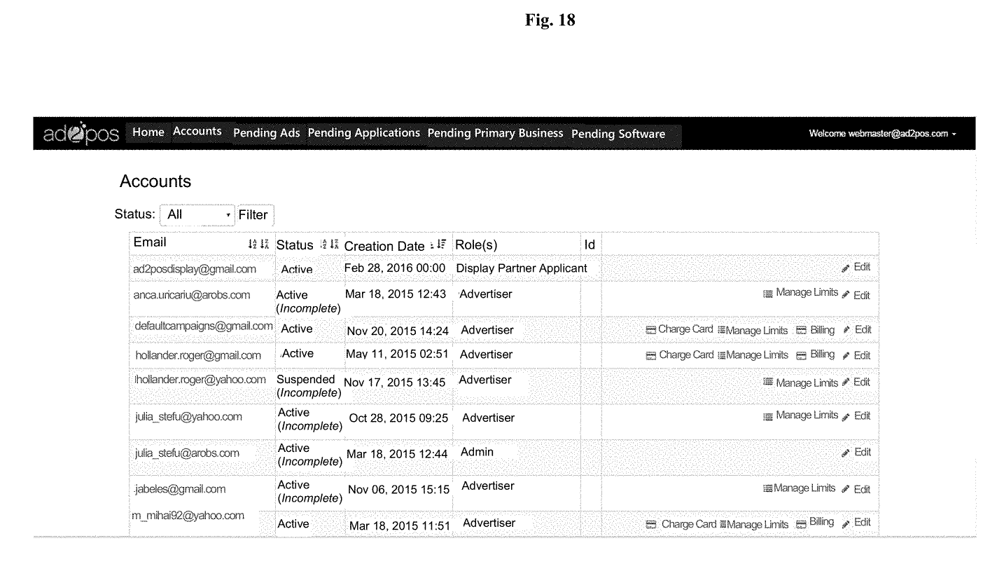

Referring to FIG. 18, in a particular embodiment, an administrator account management screen presents list of user accounts as well as sorting and filter features. In this embodiment, for each account, a status, a creation date, and a role is provided. Continuing to refer to FIG. 18, an administrator account management screen allows the administrator to edit a user account, manage limits on a user account, and/or view/edit billing and credit card information associated with an account.

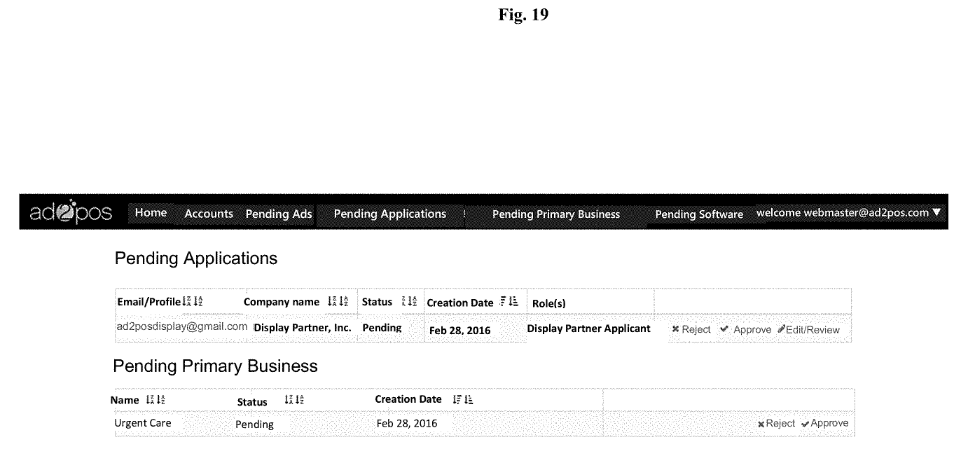

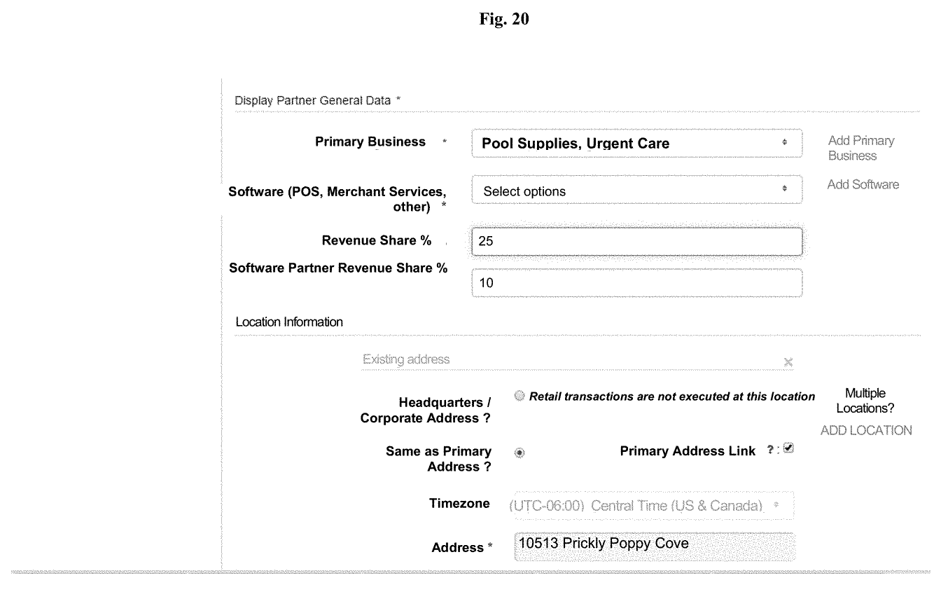

Referring to FIG. 19, in a particular embodiment, an administrator is provided with a display partner approval/rejection screen. Subsequent to approval, an administrator is able to manage the account details of a display partner, including revenue share percentage, software partner selection, and revenue share percentage for a selected software partner, from a display partner management screen (see FIG. 20).

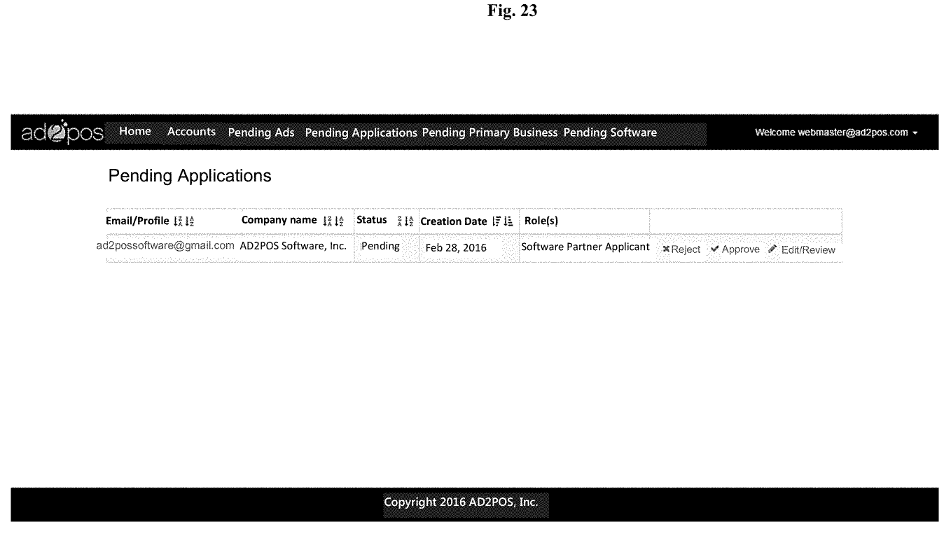

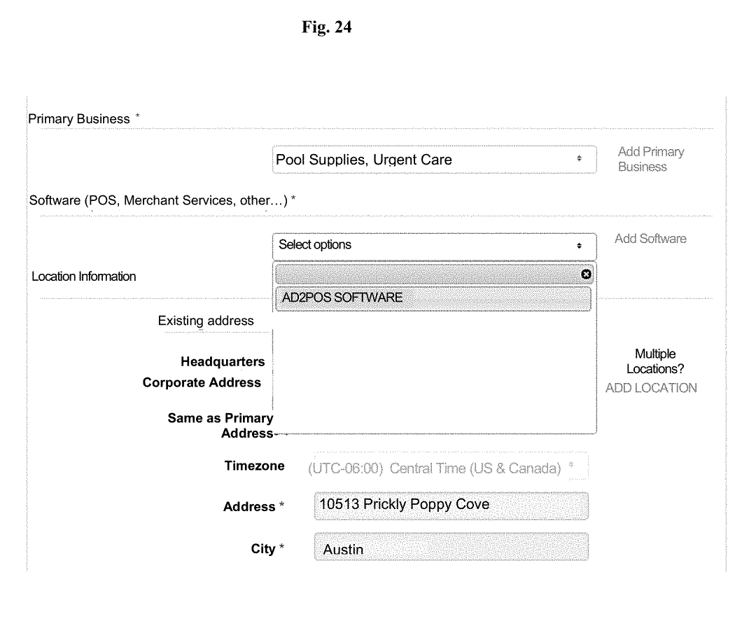

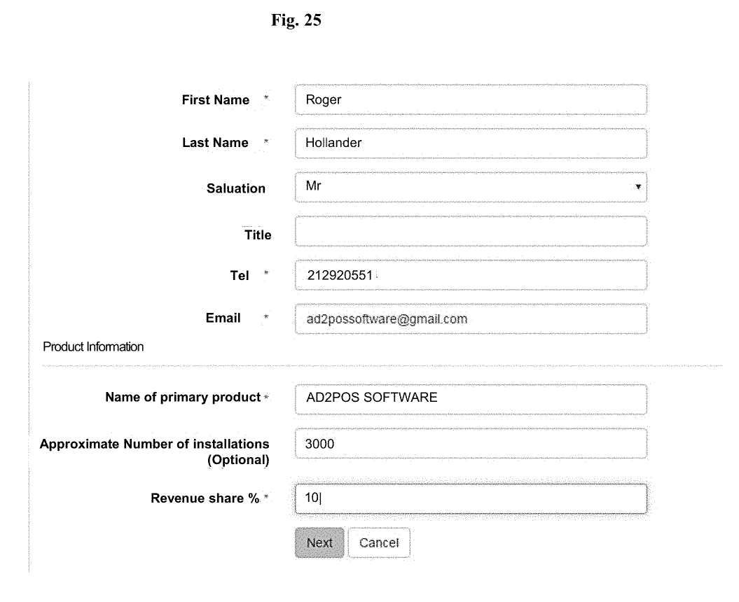

Referring to FIG. 23, in a particular embodiment, an administrator is provided with a software partner approval/rejection screen. Subsequent to approval, a software partner appears in a list allowing selection of software on a display partner screen (see FIG. 24). Moreover, subsequent to approval, an administrator is able to manage the account details of a software partner, including revenue share percentage, from a software partner management screen (see FIG. 25).

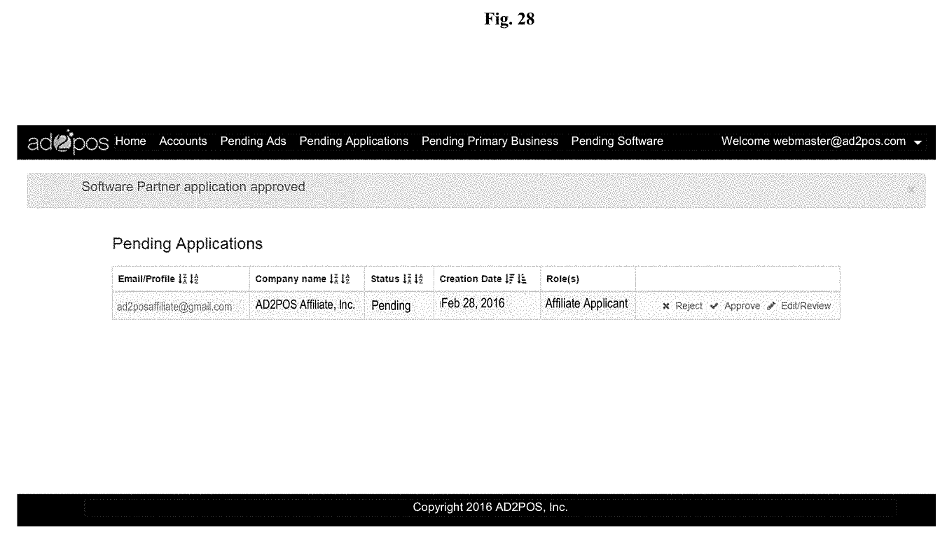

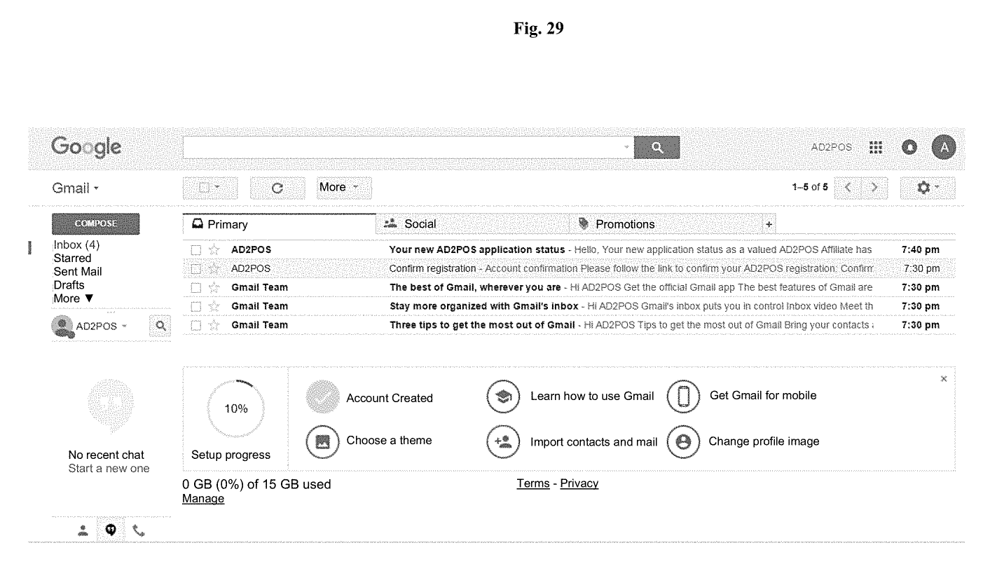

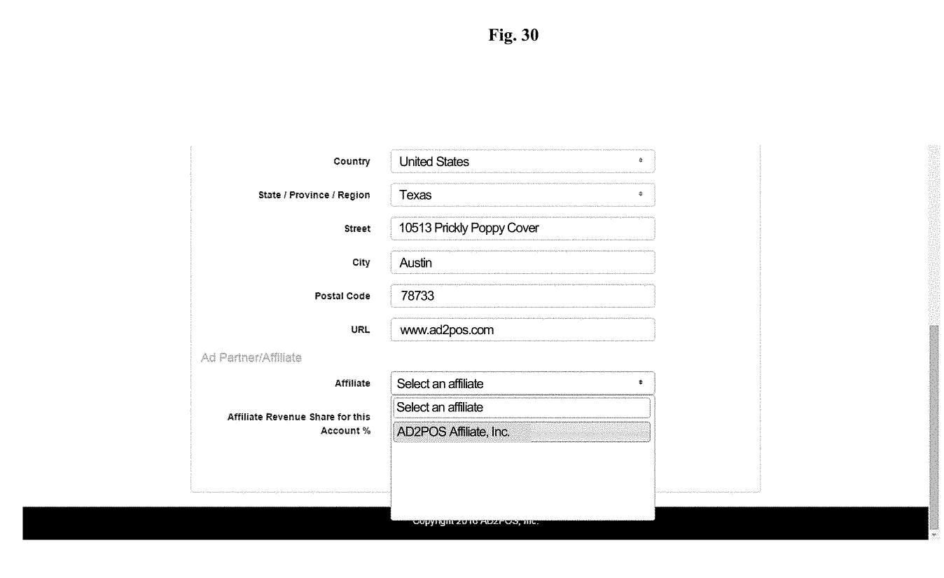

Referring to FIG. 28, in a particular embodiment, an administrator is provided with an affiliate partner approval/rejection screen. The affiliate partner is sent an email indicating approval or rejection their application (see FIG. 29). Subsequent to approval, an affiliate partner appears in a list allowing selection of affiliate on an advertiser partner screen (see FIG. 30).

### Transaction Information

In some embodiments, the platforms, systems, media, and methods described herein include transaction information, or use of the same. For example, in some embodiments, the platforms, systems, media, and methods described herein include a software module receiving transaction information for a transaction at a point-of-sale system. In further embodiments, the transaction information is received during the transaction (e.g., while the consumer is at the point-of-sale system and/or interacting with the point-of-sale system).

Many types of transaction information are available and useful. In some embodiments, the transaction information comprises a location, for example, the location the transaction is taking place. In some embodiments, the transaction information comprises a consumer identifier, for example a unique name, number, or string allowing the identity of the consumer to be determined. In further embodiments, the consumer identifier is a name, a credit card number, a debit card number, a rewards/loyalty program number, an email address, a mobile payment name, number, or account information, the MAC address, serial number, or other identifier associated with a mobile device of the consumer, or the like. In some embodiments, the transaction information comprises one or more purchase items involved in the transaction. In some embodiments, the transaction information comprises past transaction information associated with the consumer. In light of the description provided herein, those of skill in the art will recognize that any transaction information useful for identifying relevant ads to display to the consumer is suitable.

### Identification of Suitable Ads

In some embodiments, the platforms, systems, media, and methods described herein include identification of suitable ads, or use of the same. For example, in some embodiments, the platforms, systems, media, and methods described herein include a software module identifying a plurality of suitable ads from among a database of configured ads. In further embodiments, one or more suitable ads are identified based on the transaction information.

For example, in some embodiments, suitable ads are identified from a plurality of configured ads based on one or more variables input by the advertiser and associated with their respective ad including, by way of non-limiting examples, location type, physical location, and their maximum bid price per display.

### Identification of Winning Ads

In some embodiments, the platforms, systems, media, and methods described herein include identification of winning ads, or use of the same. For example, in some embodiments, the platforms, systems, media, and methods described herein include a software module selecting a winning ad, from among a database of configured ads, based on the maximum bid and the budget during the transaction. In a particular embodiment, the cost per display is one cent (or one unit as may be the case for other currencies) over the next highest bidder or defaulted to a minimum price if there is only one suitable ad configured.

### Instructions to Point-of-Sale System

In some embodiments, the platforms, systems, media, and methods described herein include instructions sent to a point-of-sale system, or use of the same.

By way of example, in some embodiments, the platforms, systems, media, and methods described herein include a software module sending receipt print instructions to the point-of-sale system. In further embodiments, the print instructions are sent to the point-of-sale system during the transaction. In still further embodiments, the print instructions comprise the content for one or more winning ads. The print instructions cause a printer associated with the point-of-sale system to print one or more winning ads on a surface of a printed receipt for the transaction.

In some embodiments, the print instructions include instructions to print one ad and include ad content for one ad. In other embodiments, the print instructions include instructions to print a plurality of ads and include ad content for a plurality of ads. In various embodiments, the print instructions include instructions to print 2, 3, 4, 5, 6, 7, 8, 9, 10, or more ads.

In some embodiments, the printer apparatus of the point-of-sale system is a one-sided printer and prints on one side of the paper receipt. In other embodiments, the printer apparatus of the point-of-sale system is a two-sided printer and prints on both sides of the paper receipt.

In some embodiments, the print instructions include instructions to print one or more ads at the top of the paper receipt. In some embodiments, the print instructions include instructions to print one or more ads at the bottom of the paper receipt. In some embodiments, the print instructions include instructions to print one or more ads in-line with the other content of the paper receipt. In some embodiments, the print instructions include instructions to print one or more ads on the back of the paper receipt.

By way of further example, in some embodiments, the platforms, systems, media, and methods described herein include a software module sending display instructions to the point-of-sale system. In further embodiments, the display instructions are sent to the point-of-sale system during the transaction. In still further embodiments, the display instructions comprise the content for one or more winning ads. The display instructions cause a display screen associated with the point-of-sale system to present one or more winning ads to the consumer during or after the transaction.

By way of still further example, in some embodiments, the platforms, systems, media, and methods described herein include a software module sending electronic receipt transmission instructions to the point-of-sale system. In further embodiments, the electronic receipt transmission instructions are sent to the point-of-sale system during the transaction. In still further embodiments, the electronic receipt transmission instructions comprise the content for one or more winning ads. The electronic receipt transmission instructions cause the point-of-sale system to transmit an electronic receipt including the one or more winning ads to the consumer after the transaction.

### Transaction Completion Information

In some embodiments, the platforms, systems, media, and methods described herein include transaction completion information, or use of the same. For example, in some embodiments, the platforms, systems, media, and methods described herein include a software module receiving transaction completion information for the transaction at the point-of-sale system. Because the platforms, systems, media, and methods described herein operate substantially in real time during the course of a transaction conducted at a point-of-sale system, follow-up information regarding the end of the transactions is useful for record keeping and for evaluating efficacy and the like.

In some embodiments, the transaction completion information is transmitted by the point-of-sale system simultaneous with or just subsequent to the completion of the transaction. In some cases, the transaction completion information includes a confirmation that the transaction was completed. In other cases, the transaction completion information includes a confirmation that the transaction was terminated without completion. In yet other cases, the transaction completion information includes a confirmation that the transaction reversed or charged back or that one or more items was returned.

### Digital Processing Device

In some embodiments, the platforms, systems, media, and methods described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile OS, Linux®, and Palm WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of, for example, campaign, ad, transaction, or user information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1—Advertiser User Experience

An advertiser completes an application to participate in the described platform (including credit card information) and is subsequently approved by a platform administrator. The advertiser uses a new campaign creation wizard to create a new targeted advertising campaign with ads to be displayed on printed receipts for particular transactions. Using the new campaign creation wizard, the advertiser enters a campaign name and description. The advertiser targets the ads to particular transactions by entering geographical (states and cities) and temporal (dates and times) footprints for the ads. The advertiser also uses the new campaign creation wizard to enter a maximum daily budget for the campaign. Next, the advertiser creates an ad within the campaign by entering a name for the ad and selecting a display media type (e.g., point-of-sale paper receipt). The advertiser uploads an ad content file (e.g., a JPEG file with a graphic, text, and a QR code) and specifies location types, days of the week, and hours of the day to target the ad to particular transactions. Finally, the advertiser enters a maximum price per display for the ad, which creates a pre-configured bid for display of the ad in applicable transactions. The ad and ad content is subjected to a compliance review by the administrator, who approves the ad. The advertiser later edits the ad. This triggers a second compliance review, which is also approved.

### Example 2—Consumer User Experience

A consumer enters a retail location and initiates purchase of an item. Information pertaining to the transaction is transmitted from the retailer's point-of-sale system to the described platform during the transaction. The transaction information includes the location, the type of retail outlet, identification of the item, identification of the consumer, as well as the day and time of the transaction. A first algorithm at the platform identifies a plurality of suitable ads based on the transaction information combined with external data including a transaction history of the user. A second algorithm at the platform programmatically selects a winning ad, based on predetermined maximum price per display and maximum daily campaign budget, during the transaction. The winning ad is the ad configured in Example 1. The platform sends print instructions to the point-of-sale system during the transaction, which include the content for the winning ad. The ad content is printed at the bottom of the receipt at the conclusion of the transaction. After the transaction, the retailer's point-of-sale system follows-up by sending a confirmation that the transaction was successfully completed and the receipt printed.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A computer-implemented system comprising: a digital processing device comprising: at least one processor, an operating system configured to perform executable instructions, a memory, and a computer program including instructions, which when executed by the at least one processor, causes the at least one processor to perform:
a) presenting an interface allowing an advertiser user to configure one or more advertising campaigns, each campaign comprising a region, a start, an end, and a maximum budget;
b) presenting an interface allowing an advertiser user to configure one or more ads, each ad associated with a configured campaign, each ad comprising one or more locations, one or more days, one or more times, content, and a maximum bid;
c) presenting an interface allowing an administrative user distinct from an advertiser user to conduct a compliance review of configured advertising campaigns and configured ads and approve or reject the configured advertising campaigns and configured ads after said configured advertising campaigns and configured ads have been configured by an advertiser user;
d) receiving transaction information for a transaction at a point-of-sale system, the information received during the transaction, the information comprising a location;
e) identifying a plurality of suitable ads based on matching the configured ads to the transaction information and selecting a winning ad based on the maximum bid and the maximum budget during the transaction, wherein the maximum bid of the winning ad is a highest bid within the plurality of suitable ads that does not cause the configured advertising campaign to exceed the maximum budget; and
f) sending receipt print instructions to the point-of-sale system during the transaction, the print instructions comprising the content for the winning ad.

2. The system of claim 1, wherein the ad content comprises text, an image, ad, a voucher, a coupon, a URL, a QR code, or a combination thereof.

3. The system of claim 1, wherein the transaction information further comprises a consumer identifier and identifying a plurality of suitable ads is further based on the consumer.

4. The system of claim 1, wherein the transaction information further comprises a purchase item and identifying a plurality of suitable ads is further based on the purchase item.

5. The system of claim 1, wherein the at least one processor further performs receiving transaction completion information for the transaction at the point-of-sale system.

6. Non-transitory computer-readable storage media encoded with a computer program including instructions, which when executed by at least one processor, causes the at least one processor to perform:
a) maintaining a database of advertising campaigns and associated ads on the media;
b) presenting an interface allowing an advertiser user to configure one or more advertising campaigns, each campaign comprising a region, a start, an end, and a maximum budget;
c) presenting an interface allowing an advertiser user to configure one or more ads, each ad associated with a configured campaign, each ad comprising one or more locations, one or more days, one or more times, content, and a maximum bid;
d) presenting an interface allowing an administrative user distinct from an advertiser user to conduct a compliance review of configured advertising campaigns and configured ads and approve or reject the configured advertising campaigns and configured ads after said configured advertising campaigns and configured ads have been configured by an advertiser user;
e) receiving transaction information for a transaction at a point-of-sale system, the information received during the transaction, the information comprising a location;
f) identifying a plurality of suitable ads based on matching the configured ads to the transaction information and selecting a winning ad based on the maximum bid and the maximum budget during the transaction, wherein the maximum bid of the winning ad is a highest bid within the plurality of suitable ads that does not cause the configured advertising campaign to exceed the maximum budget; and
g) sending receipt print instructions to the point-of-sale system during the transaction, the print instructions comprising the content for the winning ad.

7. The media of claim 6, wherein the ad content comprises text, an image, ad, a voucher, a coupon, a URL, a QR code, or a combination thereof.

8. The media of claim 6, wherein the transaction information further comprises a consumer identifier and identifying a plurality of suitable ads is further based on the consumer.

9. The media of claim 6, wherein the transaction information further comprises a purchase item and identifying a plurality of suitable ads is further based on the purchase item.

10. The media of claim 6, wherein the at least one processor further performs receiving transaction completion information for the transaction at the point-of-sale system.

11. A computer-implemented method of providing advertisers access to ad space on printed receipts comprising:
a) presenting, by a computer processor, an interface allowing an advertiser user to configure one or more advertising campaigns, each campaign comprising a region, a start, an end, and a maximum budget;
b) presenting, by the computer processor, an interface allowing an advertiser user to configure one or more ads, each ad associated with a configured campaign, each ad comprising one or more locations, one or more days, one or more times, content, and a maximum bid;
c) presenting, by the computer processor, presenting an interface allowing an administrative user distinct from an advertiser user to conduct a compliance review of configured advertising campaigns and configured ads and approve or reject the configured advertising campaigns and configured ads after said configured advertising campaigns and configured ads have been configured by an advertiser user;
d) receiving, at the computer processor, transaction information for a transaction at a point-of-sale system, the information received during the transaction, the information comprising a location;
e) identifying, by the computer processor, a plurality of suitable ads based on matching the configured ads to the transaction information and selecting a winning ad based on the maximum bid and the maximum budget during the transaction, wherein the maximum bid of the winning ad is a highest bid within the plurality of suitable ads that does not cause the configured advertising campaign to exceed the maximum budget; and
f) sending, from the computer processor, receipt print instructions to the point-of-sale system during the transaction, the print instructions comprising the content for the winning ad.

12. The method of claim 11, wherein the ad content comprises text, an image, ad, a voucher, a coupon, a URL, a QR code, or a combination thereof.

13. The method of claim 11, wherein the transaction information further comprises a consumer identifier and identifying a plurality of suitable ads is further based on the consumer.

14. The method of claim 11, wherein the transaction information further comprises a purchase item and identifying a plurality of suitable ads is further based on the purchase item.

15. The method of claim 11, further comprising receiving, at the computer processor, transaction completion information for the transaction at the point-of-sale system.

16. A computer-implemented system comprising: a digital processing device comprising: at least one processor, an operating system configured to perform executable instructions, a memory, and a computer program including instructions, which when executed by the at least one processor, causes the at least one processor to perform:
a) presenting an interface allowing an advertiser user to configure one or more advertising campaigns, each campaign comprising a region, a start, an end, and a maximum budget;
b) presenting an interface allowing an advertiser user to configure one or more ads, each ad associated with a configured campaign, each ad comprising one or more locations, one or more days, one or more times, content, and a maximum bid;
c) presenting an interface allowing an administrative user distinct from an advertiser user to conduct a compliance review of configured advertising campaigns and configured ads and approve or reject the configured advertising campaigns and configured ads after said configured advertising campaigns and configured ads have been configured by an advertiser user;
d) receiving transaction information for a transaction at a point-of-sale system, the information received during the transaction, the information comprising a location;
e) identifying a plurality of suitable ads based on matching the configured ads to the transaction information and selecting a winning ad based on the maximum bid and the maximum budget during the transaction, wherein the maximum bid of the winning ad is a highest bid within the plurality of suitable ads that does not cause the configured advertising campaign to exceed the maximum budget; and
f) sending display instructions to the point-of-sale system during the transaction, the display instructions comprising the content for the winning ad.

17. The system of claim 16, wherein the ad content comprises text, an image, a video, a URL, a QR code, or a combination thereof.

18. The system of claim 16, wherein the transaction information further comprises a consumer identifier and identifying a plurality of suitable ads is further based on the consumer.

19. The system of claim 16, wherein the transaction information further comprises a purchase item and identifying a plurality of suitable ads is further based on the purchase item.

20. The system of claim 16, wherein the at least one processor further performs receiving transaction completion information for the transaction at the point-of-sale system.

21. The system of claim 1, wherein the at least one processor allows registration of users selected from advertisers, affiliate partners, software partners, and display partners, wherein the at least one processor allows the administrative user to conduct a compliance review of a registered user and approve or reject the registered user.

22. The system of claim 21, wherein the at least one processor allows the administrative user to manage an account of a registered user by editing the account, managing limits on the account, viewing billing information associated with the account, editing billing information associated with the account, or setting a revenue share percentage.

23. The media of claim 6, wherein the at least one processor allows registration of users selected from advertisers, affiliate partners, software partners, and display partners, wherein the at least one processor allows the administrative user to conduct a compliance review of a registered user and approve or reject the registered user.

24. The media of claim 23, wherein the at least one processor allows the administrative user to manage an account of a registered user by editing the account, managing limits on the account, viewing billing information associated with the account, editing billing information associated with the account, or setting a revenue share percentage.

25. The method of claim 11, wherein the computer processor allows registration of users selected from advertisers, affiliate partners, software partners, and display partners, wherein the computer processor allows the administrative user to conduct a compliance review of a registered user and approve or reject the registered user.

26. The method of claim 25, wherein the computer processor allows the administrative user to manage an account of a registered user by editing the account, managing limits on the account, viewing billing information associated with the account, editing billing information associated with the account, or setting a revenue share percentage.

27. The system of claim 16, wherein the at least one processor allows registration of users selected from advertisers, affiliate partners, software partners, and display partners, wherein the at least one processor allows the administrative user to conduct a compliance review of a registered user and approve or reject the registered user.

28. The system of claim 27, wherein the at least one processor allows the administrative user to manage an account of a registered user by editing the account, managing limits on the account, viewing billing information associated with the account, editing billing information associated with the account, or setting a revenue share percentage.
